(19) United States
(12) Patent Application Publication
(10) Pub. No.: US 2025/0125695 A1
(43) Pub. Date: Apr. 17, 2025

(54) DESIGN AND PROCESS TO PRESS A LONG PIN INTO A STATOR LAMINATION HOLE

(71) Applicant: BorgWarner Inc., Auburn Hills, MI (US)

(72) Inventors: Andrew Dragon, Fishers, IN (US); Arlen Phillip Suter, Pendleton, IN (US); Derek Joseph Thompson, Springport, IN (US); Kristopher Graves, Fishers, IN (US)

(21) Appl. No.: 18/910,808

(22) Filed: Oct. 9, 2024

Related U.S. Application Data
(60) Provisional application No. 63/589,893, filed on Oct. 12, 2023.

(51) Int. Cl. H02K 15/02; B23P 19/02; H02K 1/18

(52) U.S. Cl. CPC H02K 15/021; B23P 19/02; H02K 1/185

(57) ABSTRACT

A method for securing a stator, including aligning a pin with an opening in a lamination stack, holding the pin with a support, the support having a surface thereof that is located at a distance from the lamination stack of at least 40 percent of a length of the pin that is exposed outside the lamination stack, and press fitting the pin into the opening. An electric machine, including a stator including a lamination stack having a first end and a second end and an ear depending from the stack, the ear including an opening, and a pin disposed, in press fit relationship, with the stator, the pin extending beyond the first and the second ends of the stator.

### CROSS REFERENCE TO RELATED APPLICATIONS

This application claims the benefit of an earlier filing date from U.S. Provisional Application Ser. No. 63/589,893 filed Oct. 12, 2023, the entire disclosure of which is incorporated herein by reference.

### BACKGROUND OF THE INVENTION

Electric motors frequently incorporate components that include conductive windings and thin metal laminations to form stators. Stators must be aligned with rotors to complete the electric machine. The stator laminations are generally between 0.2 mm to 0.3 mm thick, and are shaped into a circular form. The laminations are generally bonded or welded together and feature an inner diameter, an outer diameter, and slots extending from the inner diameter radially outwardly. The slots will house the conductive windings when a stator is formed from these components. The rotor is often disposed inside of the inner diameter of the stator and must be aligned with the stator within the electric machine

A common technique for aligning stators with rotors in an electric machine include fitting the outer diameter of the metal laminations through thermal fit or press fit operations into a precisely crafted housing. Another technique employes threaded fasteners to secure extensions of the laminations to the housing. While the techniques are effective, the thermal or press fit operations are also is costly due to the precision crafting and fitting, and the fastener based method is time consuming to minimize potential misalignment issues. Enhanced methods for producing aligned or alignable components would benefit the art.

### SUMMARY

Disclosed is a method for securing a stator, including aligning a pin with an opening in a lamination stack, holding the pin with a support, the support having a surface thereof that is located at a distance from the lamination stack of at least 40 percent of a length of the pin that is exposed outside the lamination stack, and press fitting the pin into the opening.

Disclosed is an electric machine, including a stator including a lamination stack having a first end and a second end and an ear depending from the stack, the ear including an opening, and a pin disposed, in press fit relationship, with the stator, the pin extending beyond the first and the second ends of the stator.

### BRIEF DESCRIPTION OF THE DRAWINGS

The following descriptions should not be considered limiting in any way. With reference to the accompanying drawings, like elements are numbered alike:

FIG. 1 is a schematic illustration of an electric machine;

FIG. 2 is a perspective view of a stator;

FIG. 3 is an end view of the stator of FIG. 2;

FIG. 4 is an enlarged view of FIG. 3;

FIG. 5 is a schematic view similar to FIG. 4 indicating dimensionality;

FIG. 6 is a view of a pin as disclosed herein; and

FIG. 7-11 are a sequence of views illustrating insertion of the pin into a stator in accordance with the disclosure hereof.

### DETAILED DESCRIPTION OF THE INVENTION

A detailed description of one or more embodiments of the disclosed apparatus and method are presented herein by way of exemplification and not limitation with reference to the Figures.

As disclosed herein, a new method for securing a stator in a housing that ensures proper alignment with a rotor of the electric machine employs tight fitting pins pressed into holes of the lamination to locate the stator assembly for initial alignment. If desired, some press fitting in the housing or threaded fasteners may also be employed but due to the initial alignment, both required precision in a housing is reduced and the use of threaded fasteners may be done with reduced effort and time since alignment is already assured.

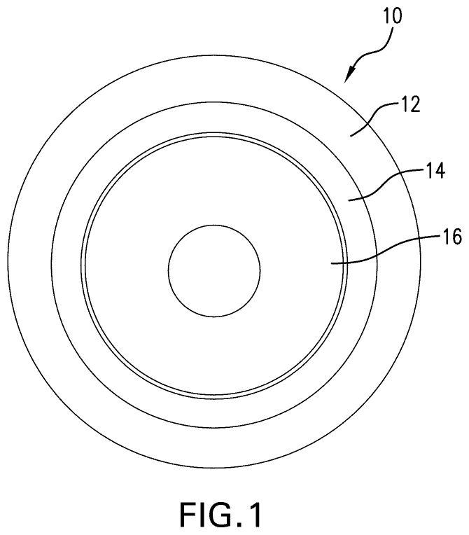

Referring to FIG. 1, an electric machine 10 is schematically illustrated. The machine 10 includes a housing 12, a stator 14 disposed in the housing 12 and aligned therein so that a rotor 16 rotatably supported by the housing will rotate within the stator 14.

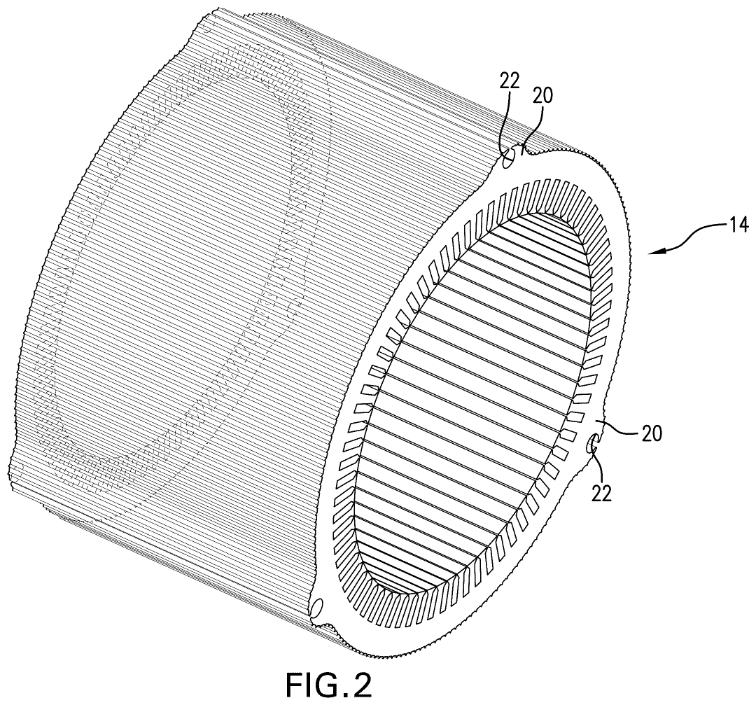

Referring to FIG. 2, the stator 14 is illustrated in perspective view. Stator 14 includes slots 18 and includes ears 20 with openings 22 therein. It will be appreciated that the stator 14 comprises a number of laminations that are not individually shown but that the slots 18 extend through all of the laminations and that a plurality of laminations will have an ear 20 that is aligned with each other lamination ear to form a column of ears wherein the openings 22 form a tubular geometry. In some embodiments, the tubular geometry will also be substantially cylindrical in form though a cylinder is not a limitation, but only an example. The stator 14 may range from about 75 mm long to about 250 mm long measured axially in various embodiments.

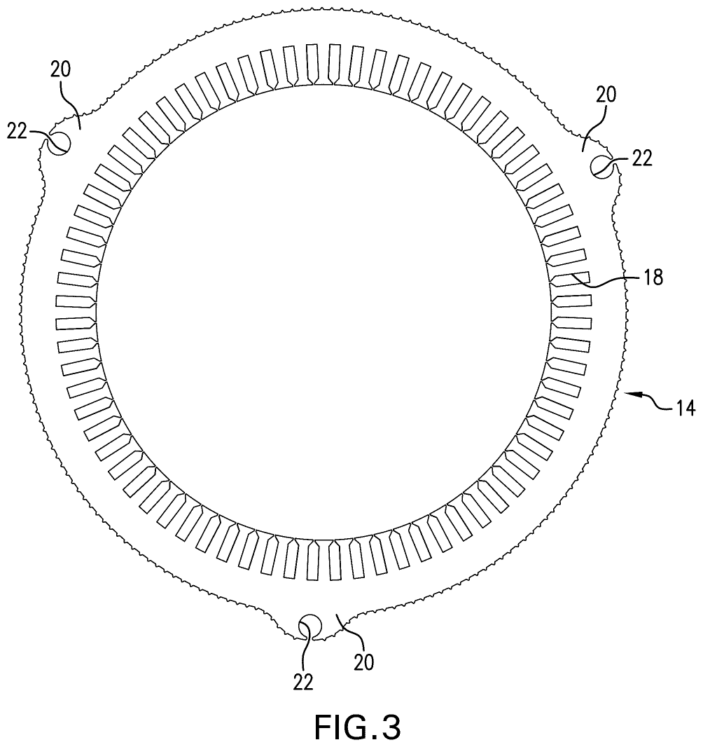

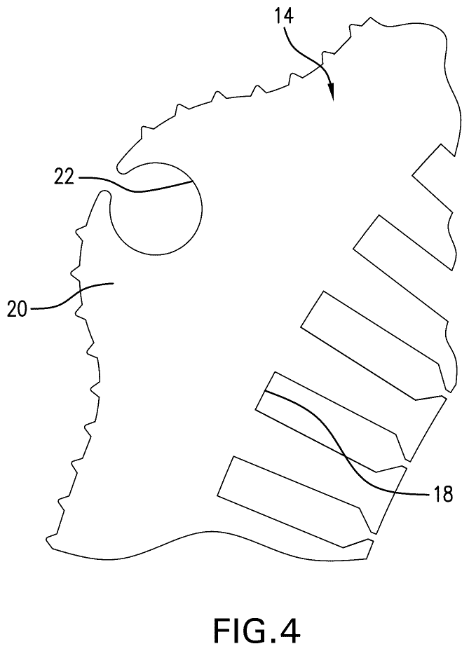

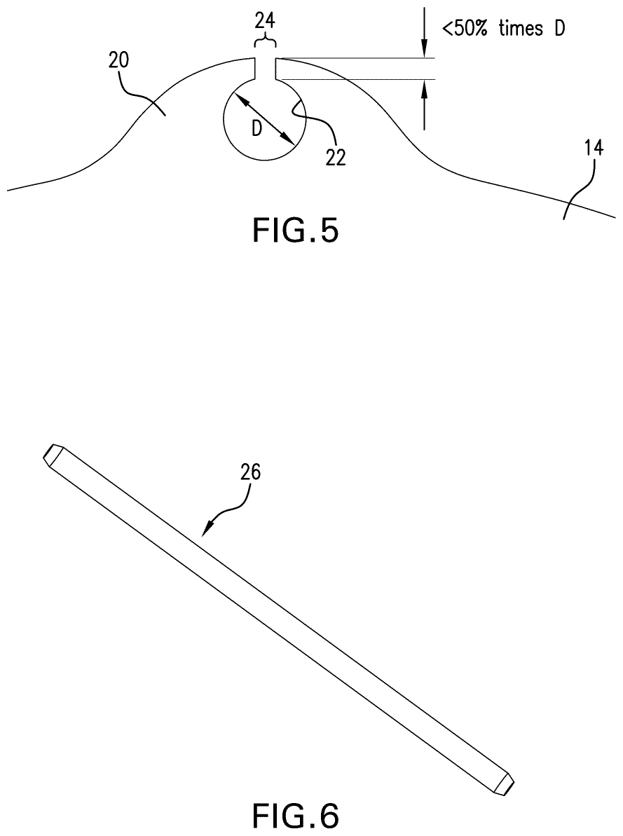

Referring to FIG. 3-5, focus is made on the openings 22 and the ears 20 that define them. More specifically, and referring directly to FIG. 5, it will be appreciated that the ear 20 is configured with radial dimension at the radially outermost portion thereof of less than 50% of the diameter of the opening 22. This is important to allow for the lamination to deform slightly to accept the press fit interference of the pin (discussed hereunder). In embodiments, there is also provided a gap 24 in the ear 20 at the radially outermost portion thereof. The gap also is helpful in allowing expansion of the opening to accept the pin during fitting. Gap width in embodiments may be from about 0.4 to about 4 millimeters measured in a circumferential direction of the stator 14.

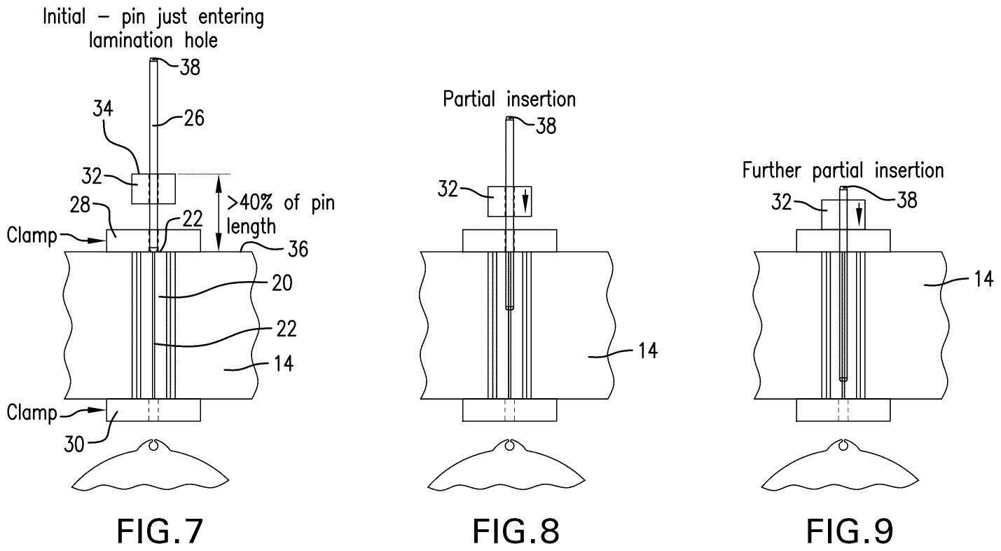

Referring to FIG. 6, a pin 26 is illustrated. Pin 26, in embodiments is about 10 mm in diameter while the diameter of opening 22 is within about +0.02 to about −0.04 millimeters of pin diameter. Differing pin diameters are contemplated with the opening diameter having similar constraints in relation thereto. The length of the pin extends about 25-about 43 mm beyond a length of the stator 14. The extension distance facilitates the location of the stator 14 in the housing 12. The housing may include openings therein that receive the pins and accordingly locate the extensions of the pins within the housing so that the stator is aligned within the housing. A cover for the housing may also have openings that likewise receive the opposing extensions of the pins and assure location and alignment with both the housing and the cover.

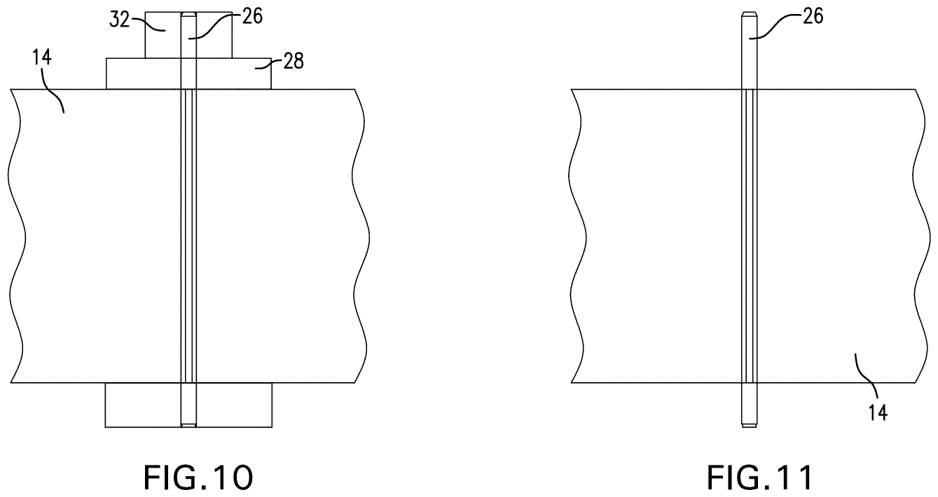

The method requires pressing the pin 26 into the opening 22 of the stator 14. Since this is an interference fit and the pin 26 is both relatively long and relatively thin, the potential for buckling/bending of the pin 26 is an issue to be addressed. It has been determined by the inventors hereof that a ratio of (pin diameter)/(lamination hole length) must be greater than 0.0464 to enhance reliability of pin insertion without bending/buckling. Increasing a hardness of the pin 26 to greater than about 320 HB (Brinell Hardness) may optionally be included. It is further noted that laminations for electric machines are stamped features. As such, there is a bur on the downstream side of the lamination, downstream being defined by the direction in which the original stamp moved relative to the blank material from which the stator lamination was produced. It has been determined by the inventors hereof that pin 26 insertion should occur in the same downstream direction to avoid the bur causing additional resistance to insertion. Employing these caveats and referring to FIGS. 7-10, the method for pin insertion is illustrated and defined.

FIGS. 7-11 illustrate schematically the pin 26 in a position just barely disposed in the opening 22 of ear 20 in stator 14 up to fully installed (FIG. 10) and final product (FIG. 11). It is also to be noted that the stator 14, or at least the ears 20 of stator 14 are clamped with clamps 28 and 30. These clamps put a compressive force on the stator 14 and should be located as closely as possible, for example within 7 millimeters from the opening 22, to the opening 22 to avoid an separation in the laminations of the stator 14. A support 32 supports the the pin 26 via a clearance hole in the support 32 wherethrough the pin 26 extends. A surface 34 of support 32 is located at a distance from a stator end 36 nearest thereto of greater than 40% of the entire pin 26 length Thickness of the support measured in the same direction as extension of the pin 26 is about the same as an intended stick out of the pin from the end 36 or the opposite end if applicable, or that length minus a thickness (measured in the same direction) of the clamp if one is used. More specifically, since as noted about stick out of the pin 26 versus the stator 14 is intended, the support thickness should be about the same as the intended stick out. In embodiments this would be 25 millimeters on one end of stator 14 and 40 millimeters on the other end of the stator 14. A load is then placed upon a pin end 38 of pin 26 and the support 32 such that both move toward the stator 14 together and force the pin 26 to move into the opening 22. When the support 32 contacts clamp 28 (or stator end 36 if no clamp is used), the support may be removed from the pin 26 leaving the stator ready for installation in the housing.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method for securing a stator, comprising:
aligning a pin with an opening in a lamination stack;
holding the pin with a support, the support having a surface thereof that is located at a distance from the lamination stack of at least 40 percent of a length of the pin that is exposed outside the lamination stack; and
press fitting the pin into the opening.

2. The method as claimed in claim 1, wherein the support includes a second surface that is located at a distance from the lamination stack of less than 40 percent of the length of the pin that extends from the lamination stack.

3. The method as claimed in claim 1, wherein the holding includes moving the support with the pin during press fitting.

4. The method as claimed in claim 3, wherein the moving is at a same speed as the pin.

5. The method as claimed in claim 1, wherein the support includes an opening therein through which the pin passes.

6. The method as claimed in claim 1, wherein the press fitting is at a ratio of pin diameter to lamination opening length of greater than 0.0464.

7. The method as claimed in claim 1, wherein a diameter of the pin and a diameter of the hole have a tolerance of +0.02 to −0.04 millimeters.

8. The method as claimed in claim 1, wherein the press fitting occurs in a same direction as the individual laminations were stamped.

9. The method as claimed in claim 1, wherein the opening is in an ear of the stator, the method further comprising clamping the ear prior to press fitting the pin.

10. The method as claimed in claim 9, wherein the clamping is at each end of the opening.

11. An electric machine, comprising:
a stator including a lamination stack having a first end and a second end and an ear depending from the stack, the ear including an opening; and
a pin disposed, in press fit relationship, with the stator; the pin extending beyond the first and the second ends of the stator.

12. The machine as claimed in claim 11, wherein a ratio of pin diameter to lamination opening length is greater than 0.0464.

13. The machine as claimed in claim 11, wherein the press fit relationship includes a tolerance in diameter of the pin and diameter of the opening of +0.02 to −0.04 millimeters.

14. The machine as claimed in claim 11, wherein the pin has a hardness of greater than about 320 Brinell Hardness (HB).

15. The machine as claimed in claim 11, wherein radial ear dimension radially outwardly of the opening is less than about 50% of opening diameter.
